(19) United States
(12) Patent Application Publication
(10) Pub. No.: US 2002/0084984 A1
(43) Pub. Date: Jul. 4, 2002

(54) Linear joystick

(76) Inventor: Stephen E. Beinor, St. Joseph, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/752,060

(22) Filed: Dec. 29, 2000

(51) Int. Cl. G09G 5/08

(52) U.S. Cl. 345/161

(57) ABSTRACT

A joystick comprising a handle, a potentiometer and a switch circuit. The handle is adapted to be moved by an operator. The potentiometer is connected to the handle and having a voltage or current divider having a resistance which varies in response to movement of the handle. The resistance has a first portion of increasing resistance as the handle is moved and has a second portion of decreasing resistance as the handle is moved. The switch circuit is responsive to movement of the handle for open circuiting the first portion or the second portion when the handle is moved.

### TECHNICAL FIELD

The invention generally relates to joysticks and, in particular, to a joystick for use with an aerial work platform which joystick provides a linear signal corresponding to joystick deflection.

### BACKGROUND OF THE INVENTION

Conventional joysticks with built in potentiometers are used to control the movement of many different types of equipment which are driven by hydraulics, motors or other power. For example, joysticks are used by operators of aerial work platforms to control the position and movement of the platforms. Usually, such joysticks control proportional hydraulic valves, variable speed hydraulic pump motor controllers and/or variable speed electric drive motor controllers. These joysticks may have either single or dual axis movement. Typical two direction single axis joysticks connect the ends of the potentiometer together so that movement of the joystick handle off center in either direction causes a corresponding change in the wiper resistance. The change is the same in either direction. If a voltage is applied to the potentiometer, then either current or voltage changes in response to movement of the joystick handle. Since the portions of the potentiometer on either side of wiper are wired in parallel, the change in resistance corresponding to movement of the joystick handle is not linear over the total range of motion of the handle. In particular, initial movement of the joystick handle for the first half of the range of movement of the wiper from center causes very little resistance change. Movement of the wiper in the last half of the travel range results in large resistance changes. The net result is a joystick that causes varying resistance change in response to handle movement. There is a need for a joystick which provides consistent resistance changes in response to handle movement to improve control of the proportional valves or motor speed providing the power.

### SUMMARY OF THE INVENTION

In one form the invention comprises a joystick including a handle, a potentiometer and a switch circuit. The handle adapted to be moved by an operator. The potentiometer is connected to the handle and has a voltage or current divider having a resistance which varies in response to movement of the handle. The resistance has a first portion of increasing resistance as the handle is moved and has a second portion of decreasing resistance as the handle is moved. The switch circuit is responsive to movement of the handle for open circuiting the first portion or the second portion when the handle is moved.

In another form, the joystick of the invention may optionally be used in combination with an aerial work platform and a controller for controlling the position of the platform. The controller is connected to and responsive to the potentiometer for linearly varying the position of the platform in response to linear variations in the resistance of the first or second portions.

In another form, the invention comprises a joystick including a handle adapted to be moved by an operator. Means connected to the handle varies a resistance in response to movement of the handle by the operator. The means for varying has a voltage or current divider having a resistance which varies in response to movement of the handle. The resistance has a first portion of increasing resistance as the handle is moved and has a second portion of decreasing resistance as the handle is moved. Means responsive to movement of the handle open circuits the first portion or the second portion when the handle is moved.

In another form, the joystick of the invention may optionally be used in combination with an aerial work platform and means for controlling the position of the platform. The means for controlling is connected to and responsive to the means for varying for linearly varying the position of the platform in response to linear variations in the resistance of the first or second portions.

The joystick of the invention has a number of advantages over the prior art. For example, the joystick of the invention provides a linear signal in response to handle movement so that the amount of change of position of the handle from any point to any other point results in a corresponding linear change in a signal generated by the joystick. The joystick of the invention also provides consistent resistance changes in response to handle movement to improve control of proportional devices and/or motors. The joystick of the invention generates a linearly varying signal representative of handle position. The joystick of the invention also provides voltage or current signals which vary linearly and in direct proportion to the amount of movement of the handle to accurately indicate desired direction and speed. The joystick of the invention may be used in combination with a controller for an aerial work platform.

Other advantages and features will be in part apparent and in part pointed out hereinafter.

### BRIEF DESCRIPTION OF THE DRAWINGS

FIG. 1 is a schematic circuit diagram of one preferred embodiment of the joystick according to the invention.

FIG. 2 is a schematic circuit diagram of one preferred embodiment of an aerial work platform system including a controller and lower control box for controlling the platform and including the joystick of the invention.

FIG. 3 is a side elevational view of one preferred embodiment of the joystick according to the invention.

FIG. 4 is a front elevational view of the joystick of FIG. 3.

Corresponding reference characters indicate corresponding parts throughout the drawings.

### DETAILED DESCRIPTION

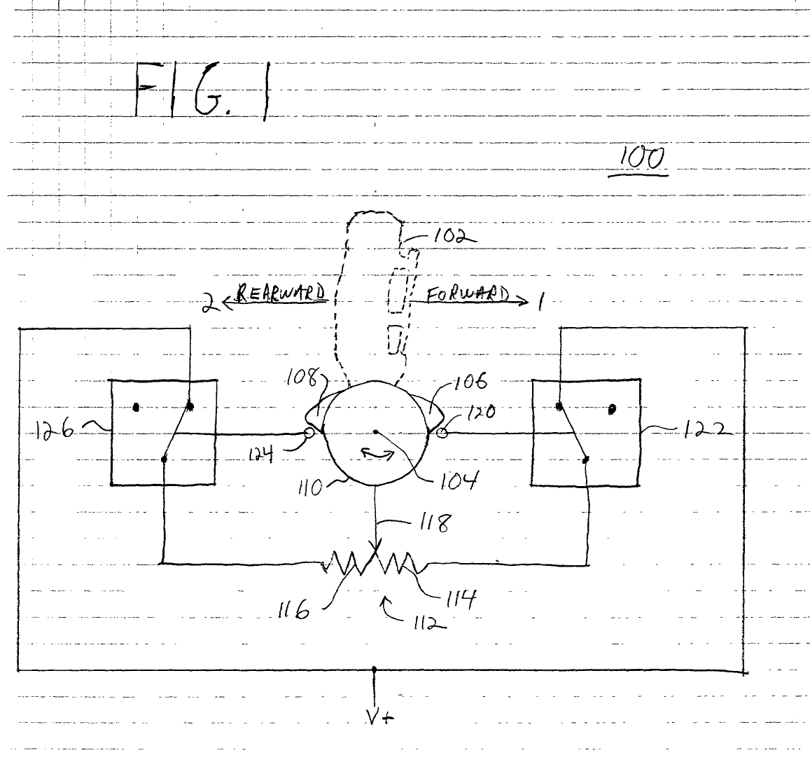

Referring to FIG. 1, a schematic circuit diagram of one preferred embodiment of a joystick 100 according to the invention is illustrated. The joystick includes a handle 102 which is controlled by an operator. For simplicity, the joystick 100 is shown as having a single axis of movement—forward as indicated by arrow 1 and backward as indicated by arrow 2. It is contemplated that the joystick may have two or more axes of movement. For example, the joystick of the invention may have two axes of movement—north/south and east/west—and it may have additional axes of movement such up/down and/or diagonal.

The handle 102 rotates about a pivot point 104. Rotation of the handle 102 by the operator causes rotational movement of a forward cam 106 which is attached to the handle 102 and pivots about pivot point 104. Rotation of the handle 102 by the operator also causes rotational movement of a rearward cam 108 which is attached to the handle 102 and pivots about pivot point 104. Rotation of the handle 102 by the operator also causes rotation of a potentiometer (pot) 110 preferably located at the pivot point 104, although other types of potentiometers such as linear pots and other types of movement of the pots are contemplated. Potentiometer 110 has a resistance as represented by resistance 112 having a first portion 114 and a second portion 116 in series with each other. Pot 110 constitutes a voltage or current divider having a resistance which varies in response to movement of the handle 102.

In general, as the handle 102 is rotated clockwise, the pot 110 is rotated clockwise moving a wiper 118 to the left which results in increasing the resistance of first portion 114 and decreasing the resistance of second portion 116. As the handle 102 is rotated counter clockwise, the pot 110 is rotated counter clockwise moving wiper 118 to the right which results in increasing the resistance of the second portion 116 and decreasing the resistance of the first portion 114. Therefore, the wiper 118 rotates in synchronization with the rotation of the handle 102 by the operator.

In addition, the forward cam 106 and the rearward cam 108 also rotate in coordination with the handle 102. In particular, as the handle 102 is rotated clockwise, the forward cam 106 and the rearward cam 108 are rotated clockwise. The forward cam 106 is profiled and configured to engage a first follower 120 to trip open a first switch 122 in response to handle movement and in series with the first portion 114 to open circuit the first portion 114. Thus, only the decreasing resistance of the second portion 116 is part of the joystick circuit as the handle 102 is rotated clockwise. As the handle is rotated counter clockwise, the forward cam 106 and the rearward cam 108 are rotated counter clockwise. The rearward cam 108 is profiled and configured to engage a second follower 124 to trip open a second switch 126 in response to handle movement in series with the second portion 116 to open circuit the second portion 116. Thus, only the decreasing resistance of the first portion 114 is part of the joystick circuit as the handle 102 is rotated counter clockwise.

As a result, the voltage (or current) signal created by the joystick 100 at the wiper 118 constitutes a linearly varying signal representative of the position of the handle 102. In particular, as the operator moves the joystick handle 102 in the direction of arrow 1 (clockwise), wiper 118 moves to the left to linearly decrease the value of the resistance of the second portion 116 and to linearly increase the voltage (or current) at wiper 118. As the operator moves the joystick handle 102 in the direction of arrow 2 (counter clockwise), wiper 118 moves to the right to linearly decrease the value of the resistance of the first portion 114 and to linearly increase the voltage (or current) of the wiper 118. Switches 122 and 126 constitute a switch circuit responsive to movement of the handle 102 for open circuiting the first portion 114 (when the handle 102 is moved forward) or for open circuiting the second portion 116 (when the handle 102 is moved rearward).

It is also contemplated that the cams 106 and 108 may be located below the first and second followers 120 and 124. In this arrangement. In this arrangement, switches 122 and 126 are configured to be a normally open circuit rather than a normally closed circuit. As the handle 102 is rotated clockwise, the forward cam 106 and the rearward cam 108 are rotated clockwise so the rearward cam 108 engages the second follower 124 to trip and close the second switch 126 in series with the second portion 116 to close circuit the second portion 116. Thus, only the decreasing resistance of the second portion 116 is part of the joystick circuit as the handle 102 is rotated clockwise. As the handle is rotated counter clockwise, the forward cam 106 and the rearward cam 108 are rotated counter clockwise so that the forward cam 106 engages the first follower 120 to trip and close the first switch 122 in series with the first portion 114 to close circuit the first portion 114. Thus, only the decreasing resistance of the first portion 114 is part of the joystick circuit as the handle 102 is rotated counter clockwise.

As a result, the signal created by the joystick 100 in this latter configuration at the wiper 118 also constitutes a linear signal representative of the position of the handle 102. In particular, as the operator moves the joystick handle 102 in the forward direction of arrow 1, wiper 118 moves to the left to linearly decrease the value of the resistance of the second portion 116 and to linearly increase the voltage at wiper 118. As the operator moves the joystick handle 102 in the direction of arrow 2, wiper 118 moves to the right to linearly decrease the value of the resistance of the first portion 114 and to linearly increase the voltage of the wiper 118.

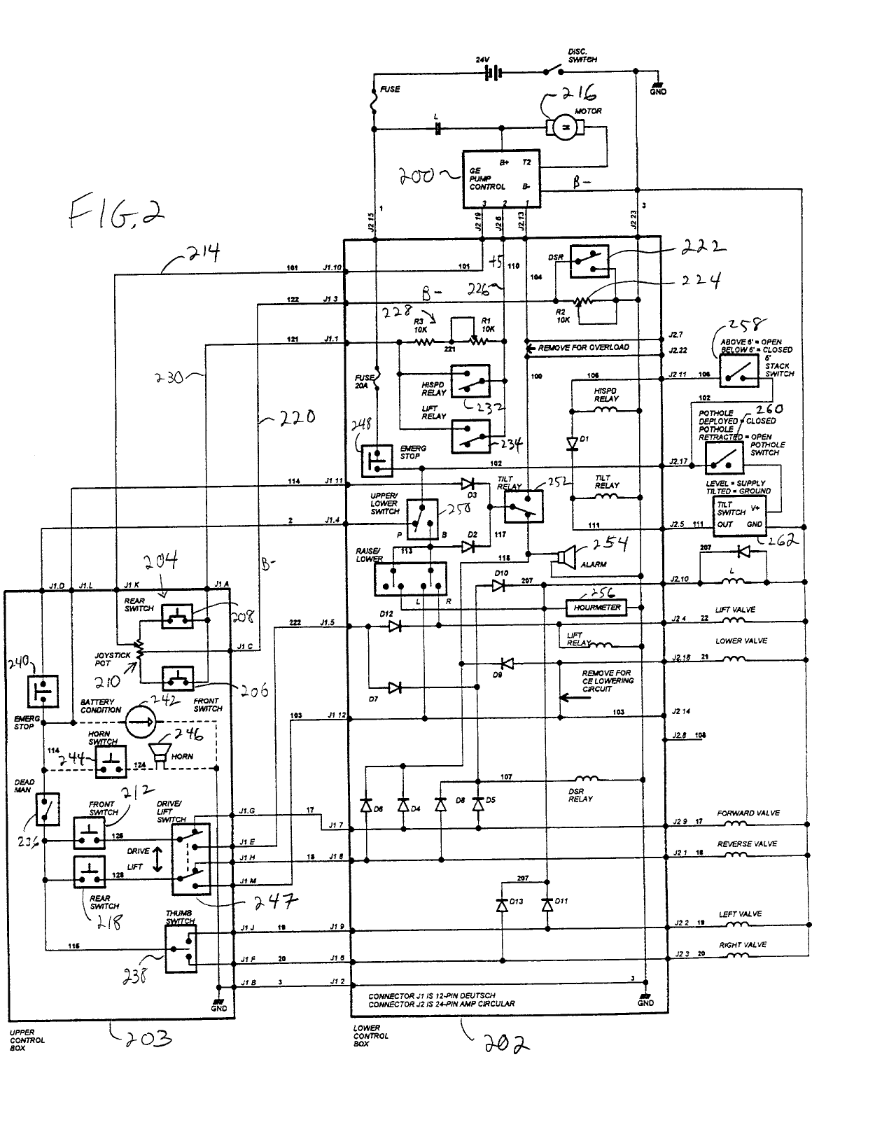

FIG. 2 is a schematic circuit diagram of one preferred embodiment of an aerial work platform system including a controller 200, a lower control box 202 for controlling an aerial work platform (not shown) and an upper control box 203 including the joystick 204 of the invention. The joystick 204 has two direction, single axis movement, forward and backward, although more degrees of motion may be implemented. To monitor the two direction, single axis movement, the joystick 204 includes a front switch 206 and a rear switch 208 responsive to movement of the joystick handle adapted to be moved by the operator (not shown in FIG. 2; see FIG. 1 and handle 102) for open circuiting a first portion or a second portion of a front/back joystick pot 210 when the handle is moved. In the case where more degrees of motion are being monitored, additional pots and switches may be employed. For example, to monitor four directions of motion, a side-to-side pot and left and right switches may be employed, in which case the left and right switches open circuit a first or second portion of the side-to-side pot when the handle is moved.

In general, the joystick 204 provides voltage or current signals which vary linearly and in direct proportion to the amount of movement of the handle to indicate the direction and speed at which the operator desires the platform to move. For example, if the operator desires the platform to move forward slowly, then the operator deflects the handle slightly forward which trips a front directional switch 212 and linearly increases the signal applied to the controller 200 via line 214. This indicates to the controller 200 to actuate a motor 216 to drive the hydraulics of the aerial work platform to result in a slow forward movement of the platform at a rate which is linearly proportional to the signal change on 214 and the amount of deflection of the handle. If the operator desires the platform to move rearward slowly, the operator deflects the handle slightly rearward which trips a rear directional switch 218 and linearly increases the signal applied to the controller 200 via line 214. This indicates to the controller 200 to actuate the motor 216 to drive the hydraulics of the aerial work platform to result in a slow rearward movement of the platform at a rate which is linearly proportional to the signal change on 214 and to the amount of deflection of the handle.

As another example, if the operator desires the platform to move forward rapidly, the operator deflects the handle completely forward which trips switch 212 and linearly increases the signal applied to the controller 200. This indicates to the controller 200 to actuate the motor 216 to drive the hydraulics of the aerial work platform to result in a forward movement of the platform at the maximum rate. If the operator desires the platform to move rearward rapidly, the operator deflects the handle completely rearward which trips switch 218 and linearly increases the signal applied to the controller 200. This indicates to the controller 200 to actuate the motor 216 to drive the hydraulics of the aerial work platform to result in a rearward movement of the platform at the maximum rate.

As a further example of one embodiment, consider the following to illustrate the linearity of the joystick. Suppose the handle can be deflected three (3) inches forward and that the voltage generated by the pot 210 is 2 volts in the undeflected position and 5 volts in the deflected position. Suppose further that the platform can be moved at a maximum rate of two miles per hour. If the operator deflects the handle forward 0.75 inches which is one-quarter of the maximum three inch deflection, then the voltage signal will increase from 2.0 volts to a 2.75 volt signal to instruct the controller 200 to move the platform forward at a rate of at 0.50 miles per hour or one-quarter of the maximum speed. If the operator further deflects the handle forward another 0.75 inches to 1.5 inches total, which is one-half of the maximum three inch deflection, then the voltage signal will increase from 2.75 volts to a 3.50 volt signal to instruct the controller 200 to move the platform forward at a rate of at 1.0 miles per hour or one-half of the maximum speed.

In FIG. 2, a grounded B- voltage is applied via drive speed relay 222 to a center tap terminal of the pot 210. The drive speed relay 222 is open when the platform in not moving (stationary) to add a resistance 224 to the joystick circuit. This added resistance simulates a movement signal when the joystick is in a neutral position so that the wheels of the platform can be turned without the need for moving the platform forward or rearward. A +5 voltage is applied via port 2 of the controller to line 226 via resistors 228 and to line 230 and switches 206 and 208. The resistors 228 decrease the voltage signal on line 214 to effect low speed operation. For high speed operation, a normally open high speed relay 232 closes to bypass resistors 228. During lifting, a lift relay 234 closes to bypass resistors 228. The joystick 204 also includes an optional dead man switch 236 which must be closed in order to actuate the joystick circuit. The switch 236 avoids inadvertent operation of the joystick. Alternatively, the dead man switch 236 may be replaced by a foot switch. The joystick 204 also includes an optional thumb switch 238 so that the operator can select which direction the wheels will be turned for steering.

Other optional features of the upper control box 203 of which the joystick 204 is part may include an emergency stop button 240, a battery condition indicator 242, a horn switch 244 for driving a horn 246, and a drive/lift switch 247. Other optional features of the lower control box 202 may include an emergency stop button 248, an upper/lower switch 250, a tilt relay 252 driving a tilt alarm 254, and an hour meter 256. Other optional features of the aerial work platform system of FIG. 2 include a 6′ stack switch 258 which closes to indicate when the stack of the aerial work platform is below 6′, a pothole leveling switch 260 to indicate whether the pothole protection device is deployed, and a tilt switch 262.

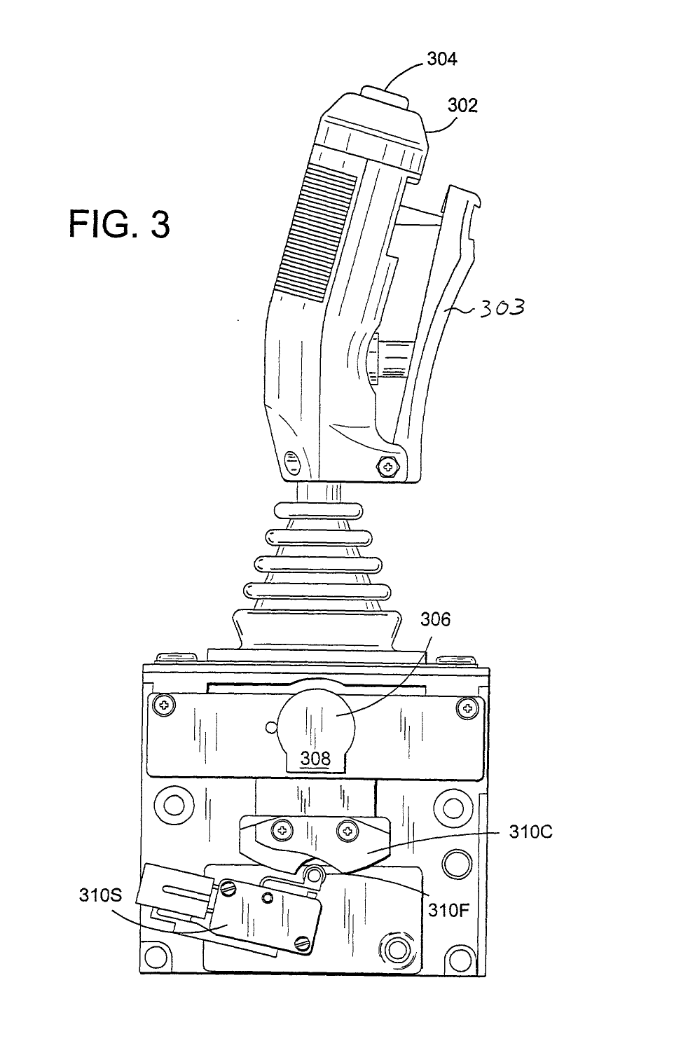

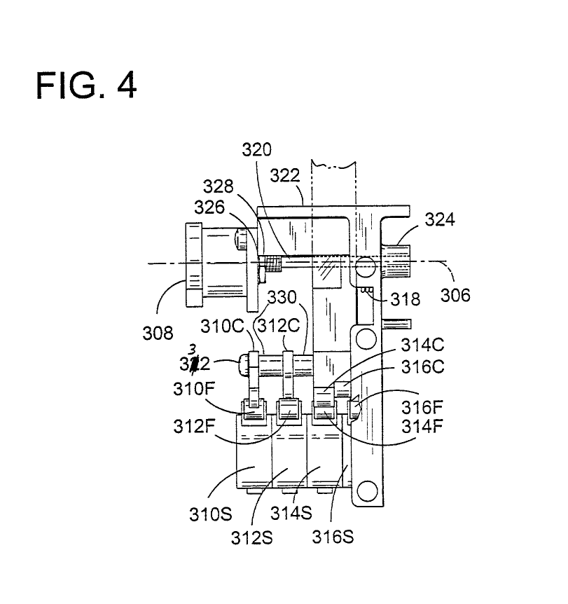

FIGS. 3 and 4 illustrate side and front views of one preferred embodiment of a joystick 300 of the invention. Handle 302 includes a dead man switch 303 which must be grasped and closed in order to activate the joystick circuit. The top of the joystick handle 302 includes a thumb steer switch 304. The handle 302 pivots about an axis 306 and rotates a pot 308. As the handle 302 is rotated by an operator, cams 310C, 312C, 314C and 316C rotate to engage followers 310F, 312F, 314F and 316F which trips open and close switches 310S, 312S, 314S and 316S. Switches 310S and 312S are the front and back switches in series with the front and back portions of the pot 308. Switches 314S and 316S are front and back direction switches for activating the hydraulics to move the platform forward or backward, respectively. A spring 318 may be provided to supply some resistance to movement of the handle and to return the handle to its central position. The handle is fixedly connected to the cams 314C and 316C so that rotational movement of the handle causes the cams 314C and 316C to rotate about a pivot pin 320 which also is affixed to the pot 318 and causes it to rotate. The pin 320 is held in place by a frame 322 having a boss 324 engaging one end of the pin and having a bore 326 engaging the other end of the pin. A nut 328 locks the pin in place. Spacers 330 and bolt 332 connect cams 310C and 312C to cam 314C so that these cams rotate in synchronization with cam 314C and the handle.

### CONCLUSION

Thus, a joystick, a joystick circuit, a joystick system and a joystick aerial work platform system have been described in which the joystick generates a linear signal corresponding to movement of the joystick. As a result, the invention tends to be more responsive, less sensitive and more accurate than prior joysticks.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A joystick comprising:
a handle adapted to be moved by an operator;
a potentiometer connected to the handle and having a voltage or current divider having a resistance which varies in response to movement of the handle, said resistance having a first portion of increasing resistance as the handle is moved and having a second portion of decreasing resistance as the handle is moved; and
a switch circuit responsive to movement of the handle for open circuiting the first portion or the second portion when the handle is moved.

2. The joystick of claim 1 wherein the first portion increases in resistance as the handle is moved in a first direction and wherein the second portion decreases in resistance as the handle is moved in the first direction.

3. The joystick of claim 2 wherein the first portion decreases in resistance as the handle is moved in a second direction and wherein the second portion increases in resistance as the handle is moved in the second direction.

4. The joystick of claim 2 wherein the switch circuit comprises a first switch in series with the first portion, said first switch responsive to movement of the handle in the first direction for open circuiting the first portion when the handle is moved in the first direction.

5. The joystick of claim 4 wherein the first switch includes a first follower which opens the first switch when engaged and further comprising a first cam movable in coordination with the handle, said first cam engaging the first follower such that movement of the handle in the first direction causes movement of the first cam which engages the first follower to trip open the first switch.

6. The joystick of claim 4 further comprising a second switch in series with the second portion, said second switch responsive to movement of the handle in the second direction for open circuiting the second portion when the handle is moved in the second direction.

7. The joystick of claim 6 wherein the second switch includes a second follower which opens the second switch when engaged and further comprising a second cam movable in coordination with the handle, said second cam engaging the second follower such that movement of the handle in the second direction causes movement of the second cam which engages the second follower to trip open the second switch.

8. The joystick of claim 1 further comprising:
an aerial work platform; and
a controller for controlling the position of the platform, said controller connected to and responsive to the potentiometer for linearly varying the position of the platform in response to linear variations in the resistance of the first or second portions.

9. A joystick comprising:
a handle adapted to be moved by an operator;
means connected to the handle for varying a resistance in response to movement of the handle by the operator, said means for varying having a voltage or current divider having a resistance which varies in response to movement of the handle, said resistance having a first portion of increasing resistance as the handle is moved and having a second portion of decreasing resistance when the handle is moved; and
means responsive to movement of the handle for open circuiting the first portion or the second portion when the handle is moved.

10. The joystick of claim 9 wherein the first portion increases in resistance as the handle is moved in a first direction and wherein the second portion decreases in resistance as the handle is moved in the first direction.

11. The joystick of claim 10 wherein the first portion decreases in resistance as the handle is moved in a second direction and wherein the second portion increases in resistance as the handle is moved in the second direction.

12. The joystick of claim 10 wherein the means for open circuiting comprises first means for switching in series with the first portion, said first means for switching responsive to movement of the handle in the first direction for open circuiting the first portion when the handle is moved in the first direction.

13. The joystick of claim 12 wherein the first means for switching includes a first follower means which opens the first means for switching when engaged and further comprising a first cam means movable in coordination with the handle, said first cam means engaging the first follower means such that movement of the handle in the first direction causes movement of the first cam means which engages the first follower means to open the first means for switching.

14. The joystick of claim 12 further comprising second means for switching in series with the second portion, said second means for switching responsive to movement of the handle in the second direction for open circuiting the second portion when the handle is moved in the second direction.

15. The joystick of claim 14 wherein the second means for switching includes a second follower means which opens the second means for switching when engaged and further comprising a second cam means movable in coordination with the handle, said second cam means engaging the second follower means such that movement of the handle in the second direction causes movement of the second cam means which engages the second follower means to open the second means for switching.

16. The joystick of claim 9 further comprising:
an aerial work platform; and
means for controlling the position of the platform, said means for controlling connected to and responsive to the means for varying for linearly varying the position of the platform in response to linear variations in the resistance of the first or second portions.
